(19) United States
(12) Patent Application Publication
(10) Pub. No.: US 2008/0295374 A1
(43) Pub. Date: Dec. 4, 2008

(54) Device for a Display Tower and a Method to Produce the Same

(75) Inventors: Jan Bergland, Onsala (SE); Hakan Skog, Billdal (SE)

Correspondence Address: POTOMAC PATENT GROUP PLLC, P. O. BOX 270, FREDERICKSBURG, VA, 22404, US

(73) Assignee: X2 NORDIC AB, Mölndal (SE)

(21) Appl. No.: 12/089,264

(22) PCT Filed: Sep. 6, 2006
(86) PCT No.: PCT/SE06/01018

§ 371 Date: Aug. 2, 2008

(30) Foreign Application Priority Data
Oct. 4, 2005 (SE) 0502181-1

(51) Int. Cl. G09F 1/06

(52) U.S. Cl. 40/607.1

(57) ABSTRACT

A new display has a base and a post, and also where appropriate, a sleeve. The display is shipped flat in a small container, and a recipient erects the post and then positions the base over it. The post is anchored to the base by adhesive. Should a sleeve be used, this is positioned over the post. The display can now carry products on spears or shelves that are inserted in or through the post. A message may be printed on the post or the sleeve. In repeated campaigns, only the sleeve need be sent out. In this way, a rational and cost-effective solution is obtained, where as much as possible of the material can be re-used. A method of manufacturing the display is also described.

The present invention relates to a device for a display tower, which has a post extending from a foot, which post is arranged to carry goods, messages, etc., and/or form support for an information agent threadable thereon.

From U.S. Pat. No. 5,787,621 A, display towers formed by a post interconnectable with a foot are previously known, the post as well as the foot being arranged to be assembable from a plane container into an intended object.

However, the foot is formed by sheets crossing each other in pairs, which in the assembled state form an X-shaped foot onto which the tower is threaded and fastened. Such a tower including a foot becomes frail and unsteady, and runs the risk of falling if someone strikes against it when it, e.g., is erected in a shop with goods or commercial advertising on the same.

By FR-A1-2 770 320, a post of board is previously known, which is stabilized by a base provided with weights. However, such a post is complicated to form and consists of a plurality of loose parts interconnectable with each other, which become difficult and time-consuming to assemble into a functional common unit.

From additional prior art, U.S. Pat. No. 5,199,813 and U.S. Pat. No. 5,860,238, respectively, show plastic traffic warning cones and signs that are stabilized by threadable weights.

These traffic facilities can be piled in each other and can be assembled, respectively, from bulky pre-formed parts, which however gives logistic problems because of the high weight and large volume of the parts.

Many of the stands that can carry graphic material are either expensive or unstable. Signs made of paper/cardboard become unstable and signs made of steel become heavy and expensive. By combining materials in a new way having individually optimal properties, it is possible to get a display that is inexpensive to produce, stable and easy to distribute.

Therefore, the main object of the present invention is primarily to provide a device for a display tower, which, among other things, solves the problems mentioned above in an efficient, cost-saving and attractive way.

Said object is attained by means of a device according to the present invention, which substantially is characterized in that the post is formed of a sheet of corrugated board or a similar material formed from a folded plane state and which along scoring lines is foldable from a said folded plane storage and transportation state into a raised tubular-forming state, that one foot-forming edge side of said sheet has at least two slot-shaped cutouts, that formed tongues between the cutouts are turnable arranged by at least 90° for providing outwardly folded feet in an folded-out state, and that a weight, surrounding said post and made from a foot-plate material formed of a hard and heavy material, has a shape-adapted reception opening for said provided post, and that said foot plate is threaded onto the post in order to weigh down and hold the feet in place in the turned-out state thereof.

The invention also relates to a method to produce a display tower, which is arranged to carry goods, messages, etc., and/or to form support for a tubular information carrier threadable onto the post according to the device mentioned above.

In that connection, an additional object is to be able to provide a method that is simple, rational and cost-saving, seen both as for the manufacture and transportation and the mounting of the product.

Said additional object is attained by a method according to the type mentioned above, which substantially is characterized in that a number of slot-shaped cutouts are provided along one edge of a sheet that consists of corrugated board or another similar material, that a plurality of scoring lines, situated at mutual distances from each other, are provided in said sheet, that a central cutout is provided in a foot-plate material formed of a hard and heavy material, that said cutout is shape-adapted to correspond with the circumference portion of the formed post, wherein, in the raised state of said sheet and the thus formed post, and after folding-out of flap-shaped feet formed between said cutouts, said foot plate is threaded on in order to weigh down and hold the feet in place in the turned-out state thereof.

The present invention is described in the following, reference being made to the accompanying drawings, in which

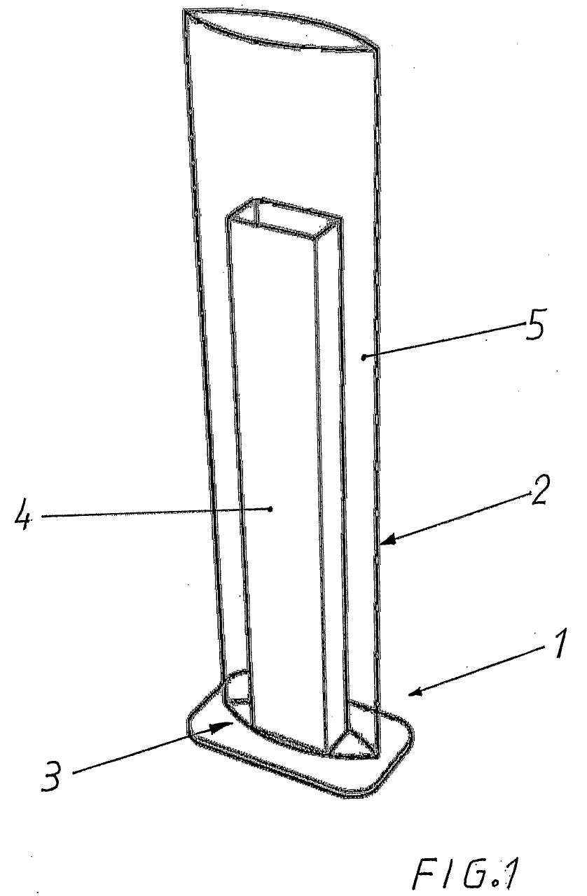

FIG. 1 shows in perspective and cross-section a display tower including an information agent,

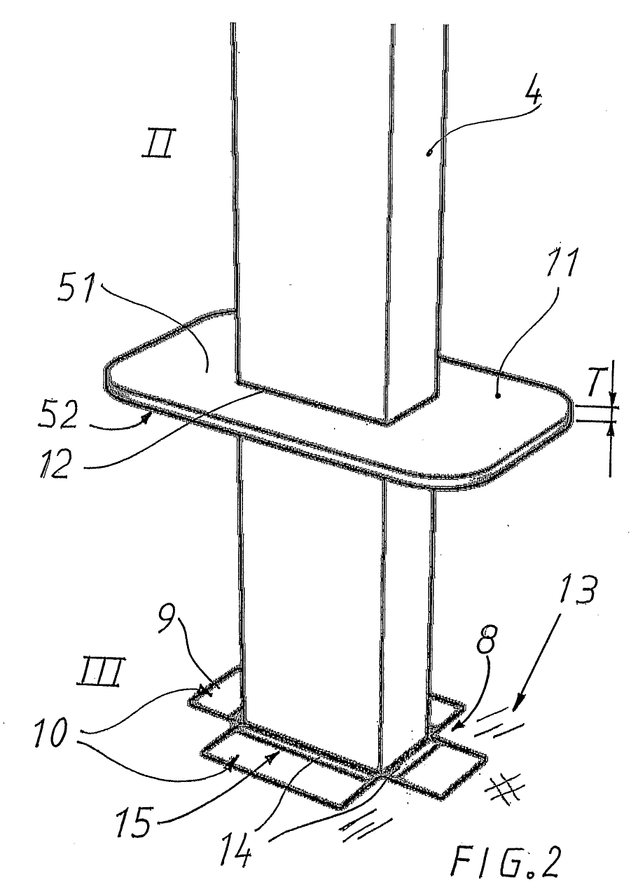

FIG. 2 shows a post and weight that the display tower is formed by and having a quadrangular cross-section shape,

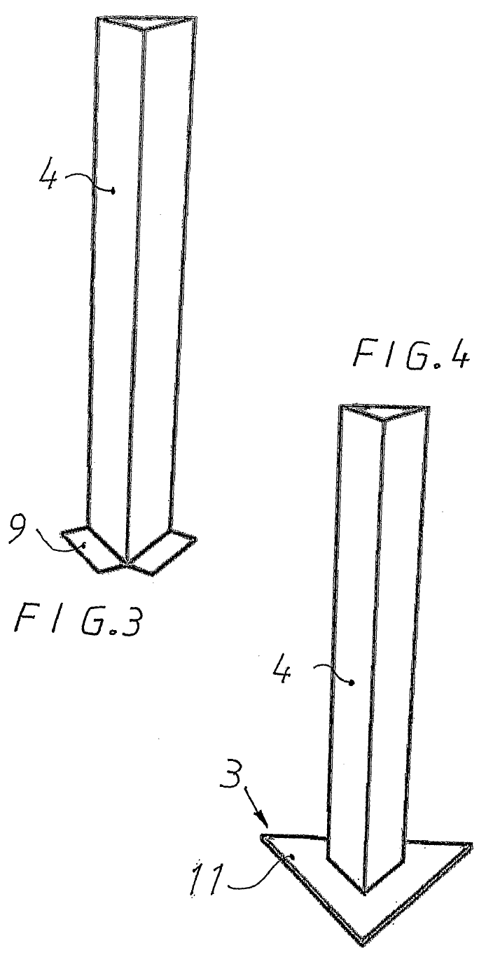

FIGS. 3 and 4 show a post having a triangular cross-section shape,

FIG. 5 shows the application of the invention in various forms,

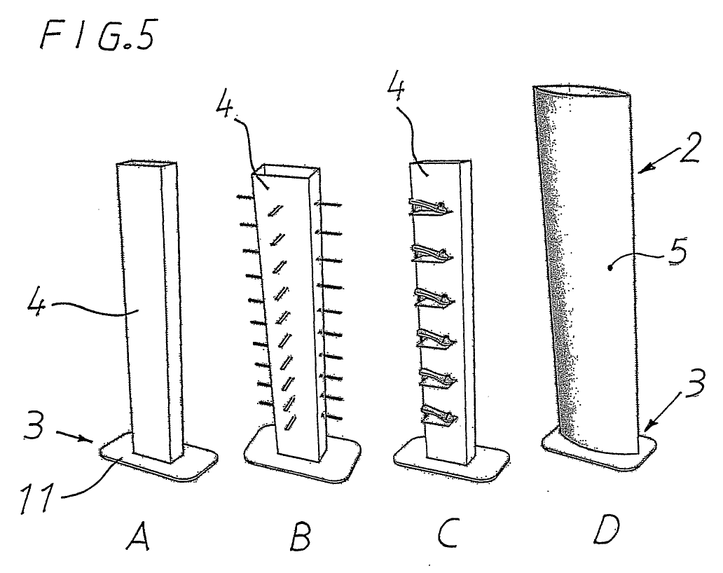

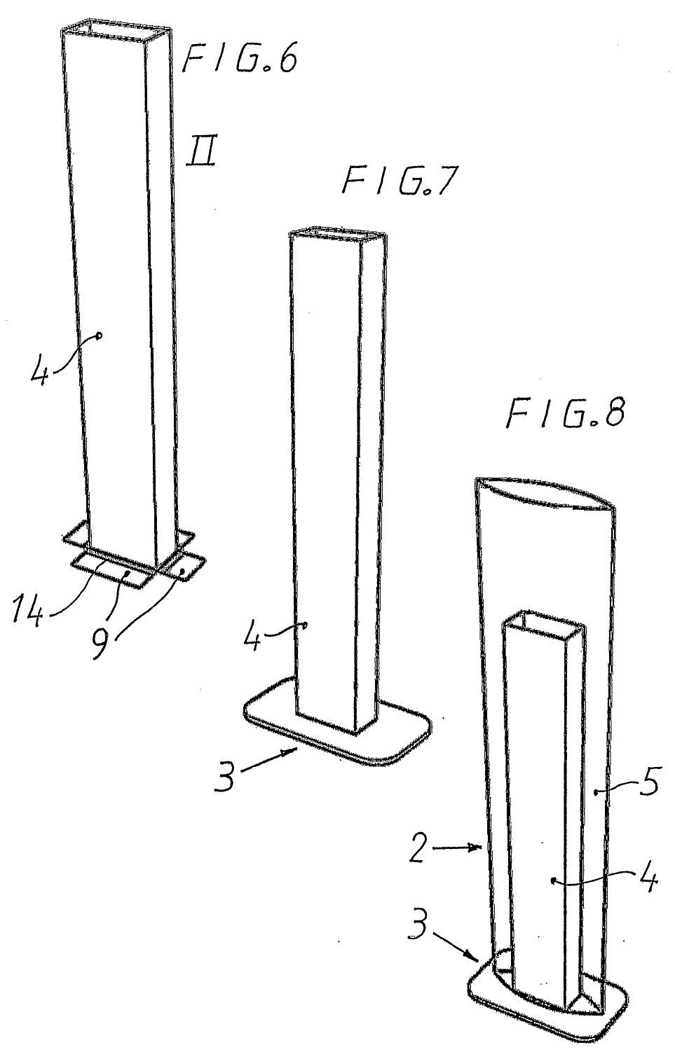

FIGS. 6-8 shows different steps for the assembly of the display tower,

FIG. 9 shows a foot plate,

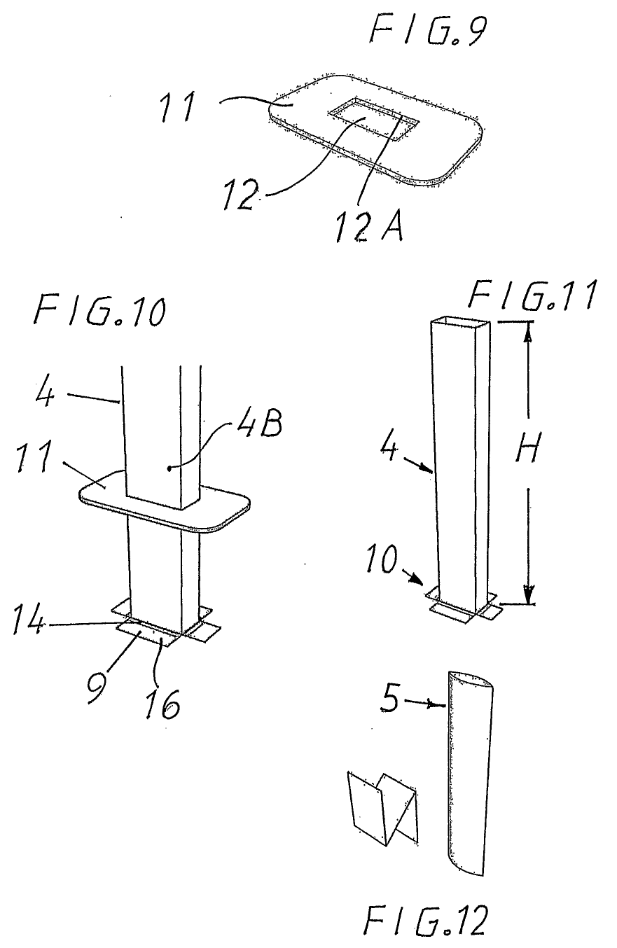

FIG. 10 shows the application of the weight onto a post,

FIG. 11 shows the post having folded-out feet,

FIG. 12 shows a folded storage state and raised state, respectively, of a tubular information agent,

FIG. 13 shows a sheet that the post is formed from, and

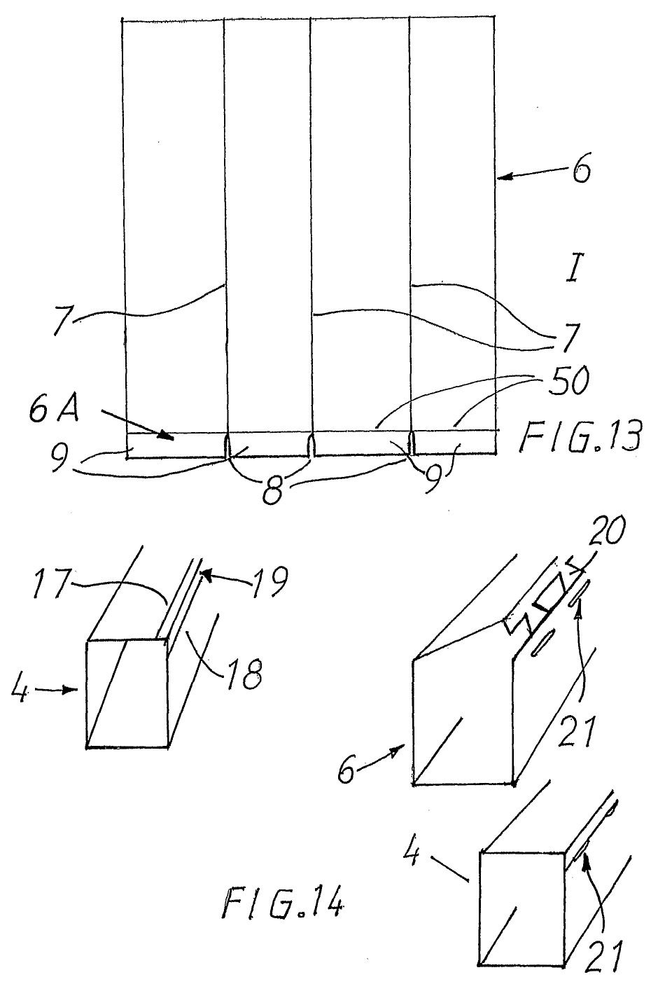

FIG. 14 shows various examples of the procedure of connecting the end edges of the sheet.

A device 1 for a display tower 2, which has a post 4 extending from a foot 3, which post is arranged to carry messages, etc., and goods on, e.g., spears, in recesses or on shelves fastened thereon in shops or at other suitable places therefor and/or to form support for a sleeve-shaped information agent 5 threadable thereon, comprises means implying that the tower according to the present invention is formed of a sheet 6, consisting of corrugated board or of another similar material, formed from a folded plane state I and which along scoring lines 7, extending along the longitudinal direction of the waved channels of the corrugated board, is foldable from a said folded plane storage and transportation state I into a raised tubular-forming standing-ready state II. One foot-forming edge side 6A of said sheet 6 has a number of slot-shaped cutouts 8. Formed tongues 9 between and beside the cutouts 8 are turnable arranged by at least 90° around transverse scorings 50 for providing outwardly folded feet 10 in an folded-out state III of said tongues 9. A weight, foot, base, etc., 11, surrounding said formed post 4 and having a reception opening 12 shape-adapted to the circumference shape of said post, is intended for the receipt of said provided post 4. Said weight 11 is arranged to abut against said tongues 9 by a surrounding external portion 51 and weigh down these in order to stabilize the post 4 against a substructure 13, and thereby form a foot 3. With surrounding, it should be appreciated that also other openings that not entirely extend along the entire circumference of said post may be a possibility, e.g., a U-shaped opening or if two such twisted foot parts laid on each other form a common foot.

Between said outwardly folded foot-forming tongues 9 and the applicable weight 11, fastening members 14 are provided, which are arranged to keep the parts 9, 11 steadily to each other.

The fastening member 14 in question is in the form of paste or other similar pasting means, e.g., double-stick carpet tape, which is arranged on at least some of said tongues 9 or on the underside 52 of the weight 11, on the area positioned at least at an adjacent portion 15 closest to the post 4 and the erected portion thereof.

In order to make the lower part of the post 4 resistant to the substructure 13 that it is intended to be erected on, said feet 10, which are formed by said outwardly turnable tongues 9, are impregnated with means imparting resistance against moisture to the same so that the post 4 withstands to remain standing when, e.g., the floor 13 that the post 4 is erected on is cleaned by a machine or manually with water. For instance, that they are coated with wax or some other similar impregnating medium at least on the formed underside 52 thereof.

The shape of said post 4 may be varied both as regards the circumference and height H thereof. For instance, the circumference shape may vary from triangular to round, with intermediate shapes such as quadrangular, rectangular and square. In that connection, said cutouts are suitably line-shaped but may also have another desired shape, such as, e.g., triangular or quadrangular flap-shaped cutouts. For a quadrangular circumference shape of the post, it is suitable that said slot-shaped cutouts 8 are arranged in alignment with the scoring lines 7 of the sheet 6 of the formed tower. For another circumference shape of the post, it is possible to arrange more cutouts between pair-wise scoring lines, but it is suitable to arrange at least one cutout 8 entirely in alignment with a scoring line 7 around which the sheet 6 is to be folded to form said post 4.

Said foot 3 consists of a plate 11 of wood, plastic or metal, such as, e.g., a sheet-metal plate, or of a combination thereof. Preferably, said foot is formed from MDF-board, which material is both compact and economically feasible. Said foot 3 is provided with a central through hole 16 shape-adapted to the entire or a part of the circumference shape of the post 4. By providing the foot 3 with a great thickness T, it is gained that stability against the post 4 is attained thanks to co-operation between the edges 12A of the hole 12 and the circumference portion 4B of the post 4 received in the hole 12.

In order to be able to form a post 4 of the foldable sheet 6, the same is arranged to be provided with fixed or disengageable joints of pair-wise interconnected meeting edges 17, 18 of the sheet 6 extending along and reaching each other. For fixed connection, a tape 19, a paste joint, seam, etc., may connect the edges 17, 18 to each other. In doing so, the assembled sheet 6, which the post 4 is intended to be formed from, may be folded from a collapsed doubled state into a folded-out state, in which it forms the intended hole-shaped post 4.

For disengageable connection of edges of a sheet meeting each other, flaps 20 and slots 21 may be arranged at pair-wise edges of the sheet meeting each other.

A method to produce a display tower 2 arranged to carry goods and/or to form support for a tubular information carrier 5 threadable onto the post 4 comprises the following steps of action:
A number of slot-shaped cutouts are provided along one edge of a sheet, which consists of corrugated board or another similar material,
a plurality of scoring lines, situated at mutual distances from each other, are provided in said sheet,
a central cutout is provided in a foot-plate material formed of a hard and heavy material, and that
said cutout is shape-adapted to correspond with the circumference portion of the formed post, wherein, in the raised state of said sheet and the thus formed tower, and after folding-out of flap-shaped feet formed between said cutouts, said foot plate is threaded on in order to weigh down and hold the feet in place in the turned-out state thereof of 90°.

Furthermore, in order to provide a reliable structural continuity between said foot plate 3 and the post 2 and particularly when said foot plate 11 does not have a considerable thickness and/or weight, e.g., if it is formed from a thin metal plate, it is possible to apply, e.g., a double-stick tape or some other adhering means 14 to a common side 16 of said sheet between said cutouts 8 and/or to the foot plate 11. It is also possible to apply a liquid-proofing medium to said formed foldable feet 10, e.g., in the form of a wax or another impregnating agent.

Below, a comprehensive and explanatory part of the construction and function of the invention follows:

The invention is based on the fact that two components of different materials are fastened to each other and co-operate in order to provide the function. A base that forms a foot and with the weight thereof presses down the flaps of a cardboard against the substructure.

### The Base

The most important property of the base is to impart tipping stability to the display. This is obtained by its own weight and area as well as by a thickness T that abuts against the circumference edge of the post. The base has a hole in the middle in order to be threadable over the post, and it may be manufactured from wood, plastic or sheet-metal plate. Also a thin punched sheet-metal plate can be used as a base, but then no stability (of the thickness) is obtained but an increased span of different materials.

### The Post

The most important property of the post is to be rigid and light. This is obtained by using corrugated board formed into geometrical shapes that give flexural rigidity (e.g., square, triangle or rectangle). Thereby, the stiffness of the channels of the corrugated board extending in the vertical direction from the substructure is utilized. Upon distribution, the post is sent plane (not raised) and may also be folded lengthwise in order to decrease the length dimension.

The post is produced in an automatic liner, which scores, cuts, applies adhesive to and waxes each work piece. The wax is applied to the bottom side so that the stand should be resistible to moisture. The adhesive is applied in order to prepare for the fixation against the base, but it works without adhesive as well.

The post may be produced with graphics on it, e.g., a suitable message, and then it becomes a “final product” without a sleeve. It may also be provided with shelves, recesses and spears for the exposure of products.

### The Sleeve

The sleeve is an attachment that is threaded outside the post in order to provide larger surfaces for graphics. The same may also be punched in order to get individual forms. For instance, as a tree. The sleeve may be folded 2-3 times lengthwise so as to become easy to distribute, such as, e.g., is shown in FIG. 12. The sleeve may be longer than the tower. In order to retain the stiffness, the scores are placed on the post and on the sleeve, respectively, in such a way that they are not facing each other.

### Mounting

First, the post is erected. The user unfolds the flat material and locks it to the shape thereof by locking lugs along the long sides and by folding-in over the short side. Alternatively, it is already glued in the production and then only needs to be pressed out to the shape thereof and be locked on the upper short side. Next, the bottom flaps of the short side are folded outward; and adhesive on the topside is activated. Then the base is threaded over the post and is attached against the adhesive on the post. A high and stable unit has now been obtained having a very low centre of gravity with the base pressing the flaps of the post against the substructure.

### Use

The unit is now ready to be used. There is a plurality of different fields of application:

A. The post shows a graphic message printed thereon.
B. The post is provided with spears.
C. The post is provided with shelves to carry products.
D. A sleeve having graphics is threaded outside the post.

In order to fasten spears or shelves on the post, an additional punch tool is needed for providing holes or slots.

If sleeves having graphics are used, the solution becomes very cost-effective in repeated campaigns. On that occasion, namely, only the sleeve is sent out. The rest of the stand is used again.

### Scrapping

When the product should no longer be used, it is easy to sort into fractions.

Naturally, the invention is not limited to the embodiments described above and shown in the accompanying drawings. Modifications are feasible, particularly as for the nature of the different parts, or by using an equivalent technique, without departing from the protection area of the invention, such as it is defined in the claims.

1-10. (canceled)

11. A display device, comprising:
a post configured to carry items or to support an information agent positionable on the post, wherein the post is formed by folding a sheet material along scoring lines from a planar state into a raised tubular state; the sheet material has a foot-forming edge side that includes at least two slot-shaped cut-outs and at least one tongue between two cut-outs, the at least one tongue being configured to be folded by at least 90° to form at least one foot in a folded-out state of the post; and
a weight having an opening configured to surround the post in its raised tubular state such that the weight holds the at least one tongue in place in the folded-out state of the post.

12. The device of claim 11, further comprising at least one fastening member that is disposed between the weight and the at least one tongue in the folded-out state of the post to keep the at least one foot and the weight together.

13. The device of claim 12, wherein the at least one fastening member is an adhesive material disposed on the at least one tongue.

14. The device of claim 13, wherein at least one the fastening member is a double-sided adhesive tape.

15. The device of claim 11, wherein the at least one tongue is moisture-proof.

16. The device of claim 15, wherein at least an underside of the at least one tongue in the folded-out state of the post is coated with a moisture-repellent material.

17. The device of claim 11, wherein the slot-shaped cut-outs are aligned with the scoring lines of the sheet material.

18. The device of claim 11, wherein the weight comprises a plate having a central through-hole, and the central through-hole has a shape adapted to the post in the tubular state of the post.

19. The device of claim 18, wherein the plate is at least one of wood, plastic, metal, and medium-density fiberboard (MDF).

20. The device of claim 11, wherein the sheet material includes a connection of pair-wise edges of the sheet material that meet each other.

21. A method of producing a display tower that includes a post arranged to carry objects or to support a tubular information carrier positionable on the post, comprising the steps of:
providing a plurality of slot-shaped cut-outs along one edge of a sheet material;
providing a plurality of scoring lines situated at distances from each other in the sheet, and
providing a central cut-out in a foot plate, the central cut-out having a shape adapted to the shape of the post when formed from the sheet material,
wherein, in a raised state of the sheet material in which the post is formed and after folding-out of flap-shaped feet formed between the cut-outs, the foot plate is positioned on the post to weigh down the post and hold the folded-out feet in place.

22. The method of claim 21, further comprising the step of applying an adhesive material on a common side of the sheet material between the cut-outs.

23. The method of claim 22, further comprising the step of applying a liquid-proofing material on the flap-shaped feet.
